(19) United States
(12) Patent Application Publication
(10) Pub. No.: US 2007/0064623 A1
(43) Pub. Date: Mar. 22, 2007

(54) Method to encapsulate SNMP over serial attached SCSI for network management operations to manage external storage subsystems

(75) Inventor: Surender Brahmaroutu, Round Rock, TX (US)

Correspondence Address: Randall C. Furlong;Baker Botts L.L.P., One Shell Plaza, 910 Louisiana Street, Houston, TX, 77002-4995, US

(73) Assignee: DELL PRODUCTS L.P.

(21) Appl. No.: 11/228,940

(22) Filed: Sep. 16, 2005

(51) Int. Cl. H04L 12/28

(52) U.S. Cl. 370/254; 370/474; 370/476

(57) ABSTRACT

According to various illustrative embodiments of the present invention, a method to encapsulate a simple network management protocol (SNMP) over a serial attached small computer system interface (SCSI) system (SAS) for network management operations to manage external storage subsystems includes encapsulating a simple network management protocol (SNMP) message having a simple network management protocol (SNMP) header and a protocol data unit (PDU) in a serial management protocol (SMP) frame for the serial attached small computer system interface (SCSI) system (SAS). The method also includes facilitating the at least one network management operation to manage the at least one external storage subsystem in-band over the serial attached small computer system interface (SCSI) system (SAS) using the simple network management protocol (SNMP) message having the simple network management protocol (SNMP) header and the protocol data unit (PDU) encapsulated in the serial management protocol (SMP) frame for the serial attached small computer system interface (SCSI) system (SAS).

### TECHNICAL FIELD OF THE INVENTION

This invention relates generally to information handling systems and, more particularly, to a method to encapsulate a simple network management protocol (SNMP) over a serial attached small computer system interface (SCSI) system (SAS) for network management operations to manage external storage subsystems.

### BACKGROUND OF THE INVENTION

As the value and use of information continues to increase, individuals and businesses continually seek additional ways to process and store information. One option available to users of information is an information handling system. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary with regard to the kind of information that is handled, how the information is handled, how much information is processed, stored, or communicated, and how quickly and efficiently the information may be processed, stored, or communicated. The variations in information handling systems allow for information handling systems to be general or configured for a specific user or specific use, including such uses as financial transaction processing, airline reservations, enterprise data storage, or global communications. In addition, information handling systems may include a variety of hardware and software components that may be configured to process, store, and communicate information and may include one or more computer systems, data storage systems, and networking systems.

Examples of information handling systems, such as computers, including servers and workstations, are often grouped in clusters to perform specific tasks. A server cluster is a group of independent servers that is managed as a single system and is characterized by higher availability, manageability, and scalability, as compared with groupings of unmanaged servers. A server cluster typically involves the configuration of a group of independent servers such that the servers appear in the network as a single machine or unit. Server clusters are often managed as a single system, share a common namespace on the network, and are designed specifically to tolerate component failures and to support the addition or subtraction of components in the cluster in a transparent manner. At a minimum, a server cluster includes two or more servers that are connected to one another by a network. The server cluster may include software driven methods by which each client of the server cluster may access the data stored in or controlled by a server of the server cluster. One software application that is used to manage the operation of a server cluster is Microsoft Cluster Service (MSCS), which is produced by the Microsoft Corporation of Redmond, Wash.

The shared storage of the server cluster may include fault tolerant data storage. One example of fault tolerant data storage is a redundant array of independent disks (RAID) storage system. RAID storage systems combine multiple disks into an array of disk drives to obtain performance, capacity, and reliability advantages. RAID Level 5 is an example of a fault tolerant data storage system. A RAID Level 5 storage system is characterized by the striping of data across the disks of the storage system. A set of parity bits generated by an exclusive-OR of the striped data bits is stored on a disk that is separate from the striped data. The parity bits for the respective stripes of data are distributed in the disks of the storage system so that each disk will likely contain both data bits for a stripe of data and parity bits related to some other stripe of data. In a RAID Level 5 storage system, it is typical that no single disk includes all of the parity bits or all of the data bits. RAID Level 5 is often referred to as a rotating parity storage system. If a disk of a RAID Level 5 storage system fails, the data (including the data bits and/or the parity bits) can be rebuilt by performing an exclusive-OR operation with the data of the other disks in the stripe, including the parity bits associated with the data stripe. Other RAID levels may be implemented for fault tolerance, including RAID 10, RAID 1, RAID 3, RAID 6, and the like, for example.

Serial attached SCSI (SAS) is primarily designed as a third-order interface to connect hard disk drives, for example, to a host computer complex. However, by virtue of being a high speed interconnect that can run up to about 100 meters or so, SAS can also be effectively used to connect hosts and external storage subsystems. Various system vendors, such as Dell, Inc., are planning on utilizing SAS for external storage connectivity, for example. In conventional configurations, hosts primarily use the SAS links for all storage operations and use a different interconnect for all network-based and/or network-related management operations, including all network-based and/or network-related management operations using a simple network management protocol (SNMP), for example. However, the system and subsystem vendors are consequently forced to incorporate management network interfaces in the designs of such dual-connected and/or multi-connected systems and subsystems in order to facilitate network-based and/or network-related management operations, driving up the costs and increasing the overall complexity due to additional cabling.

### SUMMARY OF THE INVENTION

According to various illustrative embodiments of the present invention, a method to encapsulate a simple network management protocol (SNMP) over a serial attached small computer system interface (SCSI) system (SAS) for network management operations to manage external storage subsystems includes encapsulating a simple network management protocol (SNMP) message having a simple network management protocol (SNMP) header and a protocol data unit (PDU) in a serial management protocol (SMP) frame for the serial attached small computer system interface (SCSI) system (SAS). The method also includes facilitating the at least one network management operation to manage the at least one external storage subsystem in-band over the serial attached small computer system interface (SCSI) system (SAS) using the simple network management protocol (SNMP) message having the simple network management protocol (SNMP) header and the protocol data unit (PDU) encapsulated in the serial management protocol (SMP) frame for the serial attached small computer system interface (SCSI) system (SAS).

The method disclosed herein is advantageous in providing that hosts may use SAS links for all storage operations and may also use the same SAS links for all network-based and/or network-related management operations, including all network-based and/or network-related management operations using the simple network management protocol (SNMP), for example. Consequently, the system and subsystem vendors are not forced to incorporate additional management network interfaces in the designs of storage systems and subsystems in order to facilitate network-based and/or network-related management operations, thereby driving down the costs and decreasing the overall complexity due to the absence of any additional cabling. Other technical advantages will be apparent to those of ordinary skill in the art having the benefit of the present disclosure and in view of the following specification, claims, and drawings.

### BRIEF DESCRIPTION OF THE DRAWINGS

The following figures form part of the present specification and are included to further demonstrate certain aspects of the present invention, and should not be used to limit or define the present invention. The present invention may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which the leftmost significant digit(s) in the reference numerals denote(s) the first figure in which the respective reference numerals appear, wherein:

FIG. 1 schematically illustrates a block diagram showing an information handling system, according to teachings of the present disclosure;

FIG. 2 schematically illustrates a block diagram showing an exemplary embodiment of a storage system including a controller mounted on an internal backplane having hard disk drives (HDD) and a stand-alone enclosure coupled to the controller having additional HDD connected via a SCSI bus, according to teachings of the present disclosure;

FIG. 3 schematically illustrates a block diagram showing an exemplary embodiment of a storage system including a controller mounted on an internal backplane having hardware devices such as HDD connected via a point-to-point link, according to teachings of the present disclosure;

FIG. 4 schematically illustrates a block diagram of a server cluster network;

FIG. 5 schematically illustrates a block diagram of a shared storage unit;

FIG. 6 schematically illustrates a diagram of a drive array;

FIG. 7 schematically illustrates a diagram of a system with a host, clients, and a storage subsystem useful in various exemplary embodiments, according to teachings of the present disclosure;

FIG. 8 schematically illustrates a layering of a simple network management protocol (SNMP) over serial attached small computer system interface (SCSI) system (SAS) layers of protocols useful in various exemplary embodiments, according to teachings of the present disclosure;

FIG. 9 schematically illustrates a simple network management protocol (SNMP) message having a message header and a protocol data unit (PDU) useful in various exemplary embodiments, according to teachings of the present disclosure;

FIG. 10 schematically illustrates a serial attached small computer system interface (SCSI) system (SAS) serial management protocol (SMP) response frame format with a simple network management protocol (SNMP) message encapsulated in the serial attached small computer system interface (SCSI) system (SAS) serial management protocol (SMP) frame, showing the simple network management protocol (SNMP) message tunneling over the serial attached small computer system interface (SCSI) system (SAS) in various exemplary embodiments, according to teachings of the present disclosure; and

FIG. 11 schematically illustrates an exemplary method to encapsulate a simple network management protocol (SNMP) over a serial attached small computer system interface (SCSI) system (SAS) for network management operations to manage external storage subsystems, according to teachings of the present disclosure.

It is to be noted, however, that the appended drawings illustrate only typical embodiments of the present invention and are, therefore, not to be considered limiting of the scope of the present invention, as the present invention may admit to other equally effective embodiments.

### DETAILED DESCRIPTION OF EXEMPLARY EMBODIMENTS OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Illustrative embodiments of the present invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

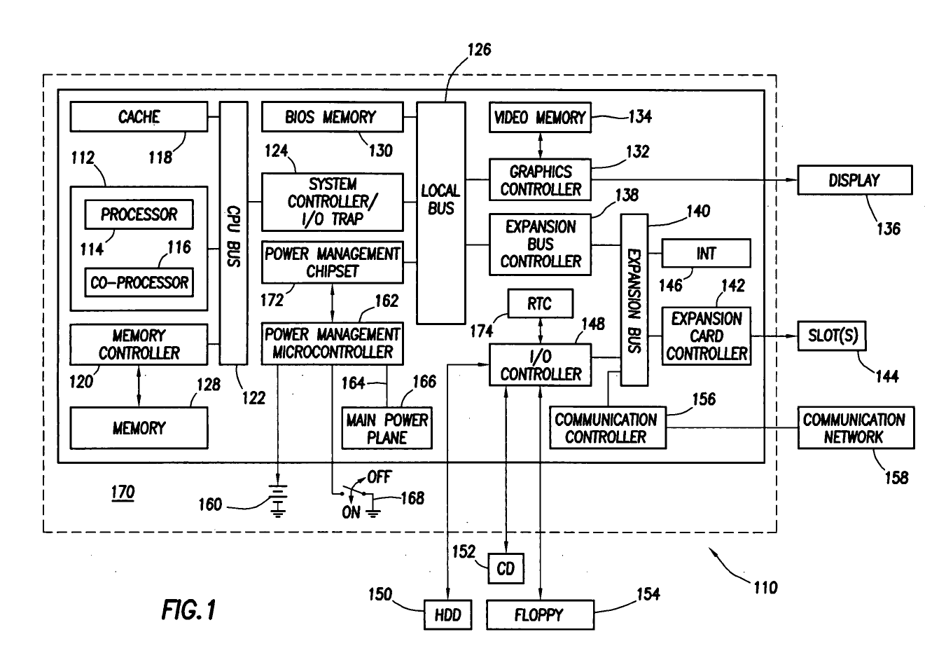

Referring first to FIG. 1, a block diagram of an information handling system 110 is shown, according to teachings of the present disclosure. The information handling system 110 or the computer system 110 preferably may include at least one microprocessor or central processing unit (CPU) 112. The CPU 112 may include a processor 114 for handling integer operations and a co-processor 116 for handling floating point operations. The CPU 112 may preferably be coupled to a cache 118 and a memory controller 120 via a CPU bus 122. A system controller input/output (I/O) trap 124 preferably may couple the CPU bus 122 to a local bus 126 and may be generally characterized as part of a system controller.

A main memory 128 of dynamic random access memory (DRAM modules may preferably be coupled to the CPU bus 122 by the memory controller 120. The main memory 128 may be divided into one or more areas such as a system management mode (SMM) memory area (not expressly shown).

A basic input/output system (BIOS) memory 130 may also preferably be coupled to the local bus 126. A FLASH memory or other nonvolatile memory may be used as the BIOS memory 130. A BIOS program (not expressly shown) may typically be stored in the BIOS memory 130. The BIOS program preferably may include software that facilitates interaction with and between the information handling system 110 devices such as a keyboard (not expressly shown), a mouse (not expressly shown), and/or one or more I/O devices. The BIOS memory 130 may also store system code (note expressly shown) operable to control a plurality of basic information handling system 110 operations.

A graphics controller 132 may preferably be coupled to the local bus 126 and to a video memory 134. The video memory 134 may preferably be operable to store information to be displayed on one or more display panels 136. The display panel 136 may be an active matrix or passive matrix liquid crystal display (LCD), a cathode ray tube (CRT) display, and/or another display technology. In selected applications, uses and/or instances, the graphics controller 132 may also be coupled to an integrated display, such as in a portable information handling system implementation.

A bus interface controller or expansion bus controller 138 may preferably couple the local bus 126 to an expansion bus 140. In various illustrative embodiments, the expansion bus 140 may be configured as an industry standard architecture (ISA) bus. Other buses, for example, a peripheral component interconnect (PCI) bus, may also be used.

In certain information handling system 110 embodiments, an expansion card controller 142 may also be included and may preferably be coupled to the expansion bus 140 as shown in FIG. 1. The expansion card controller 142 may preferably be coupled to a plurality of information handling system 110 expansion slots 144. The expansion slots 144 may be configured to receive one or more computer components (not expressly shown) such as an expansion card (e.g., modems, fax cards, communications cards, and/or other I/O devices).

An interrupt request generator 146 may also preferably be coupled to the expansion bus 140. The interrupt request generator 146 may preferably be operable to issue an interrupt service request over a predetermined interrupt request line in response to receipt of a request to issue an interrupt instruction from the CPU 112.

An I/O controller 148, often referred to as a super I/O controller 148, may also preferably be coupled to the expansion bus 140. The I/O controller 148 may preferably interface to an integrated drive electronics (IDE) hard drive device (HDD) 150, a compact disk-read only memory (CD-ROM) drive 152, and/or a floppy disk drive (FDD) 154. Other disk drive devices (not expressly shown) that may be interfaced to the I/O controller 148 include a removable hard drive, a zip drive, a CD-RW (compact disk-read/write) drive, and a CD-DVD (compact disk-digital versatile disk) drive.

A communication controller 156 may preferably be provided and may enable the information handling system 110 to communicate with a communication network 158, for example, an Ethernet network. The communication network 158 may include a local area network (LAN), a wide area network (WAN), the Internet, an Intranet, wireless broadband, and the like. The communication controller 156 may be employed to form a network interface for communicating with other information handling systems (not expressly shown) coupled to the communication network 158.

As shown in FIG. 1, the information handling system 110 may preferably include a power supply 160, which may provide power to the many components and/or devices that form the information handling system 110. The power supply 160 may be a rechargeable battery, such as a nickel metal hydride (NiMH) or a lithium ion battery, when the information handling system 110 is embodied as a portable or notebook computer, an A/C (alternating current) power source, an uninterruptible power supply (UPS) or other power source.

The power supply 160 may preferably be coupled to a power management microcontroller 162. The power management microcontroller 162 may preferably control the distribution of power from the power supply 160. More specifically, the power management microcontroller 162 may preferably include a power output 164 coupled to a main power plane 166 that may supply power to the CPU 112 as well as to other information handling system 110 components. The power management microcontroller 162 may also be coupled to a power plane (not expressly shown) operable to supply power to an integrated panel display (not expressly shown), as well as to additional power delivery planes that preferably may be included in the information handling system 110.

The power management microcontroller 162 may preferably monitor a charge level of an attached battery and/or a UPS to determine when and when not to charge the battery or the UPS. The power management microcontroller 162 may preferably also be coupled to a main power switch 168, which the user may actuate to turn the information handling system 110 on and off. While the power management microcontroller 162 may power down one or more portions or components of the information handling system 110, for example, the CPU 112, the display 136, and/or the HDD 150, and the like, when not in use to conserve power, the power management microcontroller 162 itself may preferably be substantially always coupled to a source of power, preferably the power supply 160.

A computer system, a type of information handling system 110, may also include a power management chip set 172. The power management chip set 172 may preferably be coupled to the CPU 112 via the local bus 126 so that the power management chip set 172 may receive power management and control commands from the CPU 112. The power management chip set 172 may preferably be connected to a plurality of individual power planes operable to supply power to respective components of the information handling system 110, for example, the HDD 150, the FDD 154, and the like. In this manner, the power management chip set 172 may preferably act under the direction of the CPU 112 to control the power supplied to the various power planes and components of a system.

A real-time clock (RTC) 174 may also be coupled to the I/O controller 148 and the power management chip set 172. Inclusion of the real-time clock (RTC) 174 may permit timed events and/or alarms to be transmitted to the power management chip set 172. The real-time clock (RTC) 174 may be programmed to generate an alarm signal at a predetermined time as well as to perform other operations.

The information handling system 110 may be associated with a chassis 170. Generally, the chassis 170 may be referred to as the computer case and/or case that encloses the some of the components within the information handling system 110. However, other components such as the CD drive 152, the floppy drive 154 and/or the HDD 150, may be placed internal to the chassis 170 and/or separately from the chassis 170 in a stand-alone enclosure (described below in more detail) and/or connected in series.

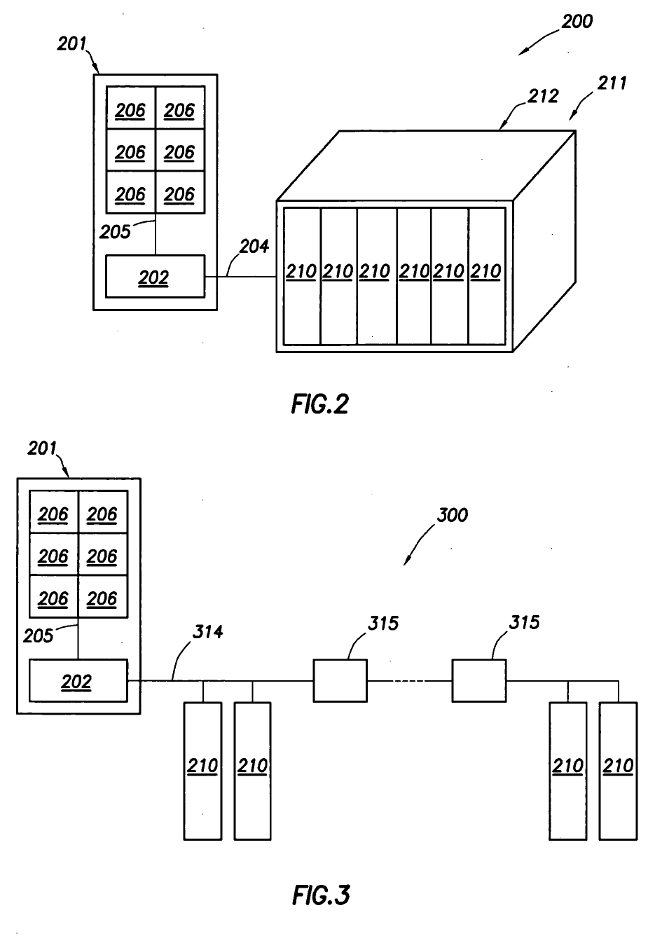

As shown in FIGS. 2 and 3, for example, one or more computer components may be communicatively connected to the information handling system 110 via a bus 204, as described below in more detail, or through a point-to-point link 314. In some embodiments, the information handling system 110 may include a storage system 200 (described below in more detail) that uses a small computer system interface (SCSI), Fibre Channel, serial attached SCSI (SAS), and/or other standard for communications between components and/or devices and the system. One example of a point-to-point link in an SAS storage subsystem may include a group of links also known as a “fabric” that uses a Fibre Channel standard for interfacing between controllers and drives.

FIGS. 2 and 3 are block diagrams showing various exemplary embodiments of the storage system 200, including a small computer system interface (SCSI) storage subsystem 211 and a serial attached SCSI (SAS) storage subsystem 300, respectively. Each storage subsystem 200 may include a controller 202 mounted on an internal backplane 201 having hard disk drives (HDDS) 206. The SCSI storage subsystem 211 may further include a stand-alone enclosure 212 that may include input/output (I/O) expanders coupled to a controller 202 having additional SCSI devices such as the HDDs 210 connected via a SCSI bus 204. The SAS storage subsystem 300 may further include additional SCSI devices such as the HDDs 210 interconnected via the point-to-point link 314. In various illustrative embodiments, the SAS storage subsystem 300 may further include one or more expanders 315 that may be operable to regenerate, reshape, and/or retransmit a SCSI signal to additional SCSI devices such as the HDDs 210 interconnected via the point-to-point link 314.

A SCSI/SAS storage system such as storage system 200 may include a plurality of hardware and/or SCSI devices such as the internal hard disk drives (HDDs) 206 and the external hard disk drives (HDDs) 210 that are connected via I/O expanders. Other examples of SCSI devices may include tape drives (not expressly shown) and/or compact disk drives (not expressly shown).

The I/O expanders may allow the SCSI devices to connect to the storage system 200. The I/O expanders may include the SCSI expanders 315 that may include expander chips (not expressly shown), the internal backplane 201 and/or the enclosure 212 that may have connections for the SCSI devices to communicate with the storage system 200 via a SCSI bus such as the internal bus 205 and the external bus 204. Useful exemplary enclosures 212 may include a PowerVault 220 system and/or a PowerVault 210 system manufactured by Dell, Inc. Because the SCSI devices may reside at different locations and/or configurations within the storage system 200, the controller 202 may be used to direct communications to the address associated with each SCSI device.

The SAS storage subsystem 300 may further include one or more SCSI expanders 315 that may be used to link and/or interconnect with one or more hardware devices such as the HDD 210. However, there may not necessarily be one SCSI expander for each hardware device such as the hard disk drive (HDD) 210.

Each hardware and/or SCSI device within the storage system 200 may be represented as a SCSI target. Each SCSI device may include an address for communications between a processor and memory (not expressly shown) in the storage system 200 via an I/O controller such as the controller 202 shown on the internal backplane 201. The controller 202 may direct information between the SCSI devices via the internal bus 205 and/or the external bus 204.

The connections on SCSI devices may be interchangeable such that an internal SCSI device such as the internal HDD 206 may be placed in the enclosure 212, having an I/O expander. Similarly, the external HDD 210 may connect to the internal backplane 201 in lieu of the internal HDD 206.

Even though the SCSI devices may physically connect at the different locations, compatibility issues may arise such as the SCSI device may not be supported. Thus, the controller 202 may perform a scan for devices placed on interconnections such as the bus 204 and the point-to-point link 314 for devices associated with storage system 200 to identify potential compatibility issues. For example, compatibility issues may arise between a combination of the SCSI controller and an SCSI hardware device, the SCSI controller and an attached enclosure, the enclosure and an SCSI device, and the SCSI device and another SCSI device. Furthermore, firmware compatibility issues may arise such as one or more of the devices may not have the most up-to-date revision of the appropriate respective firmware.

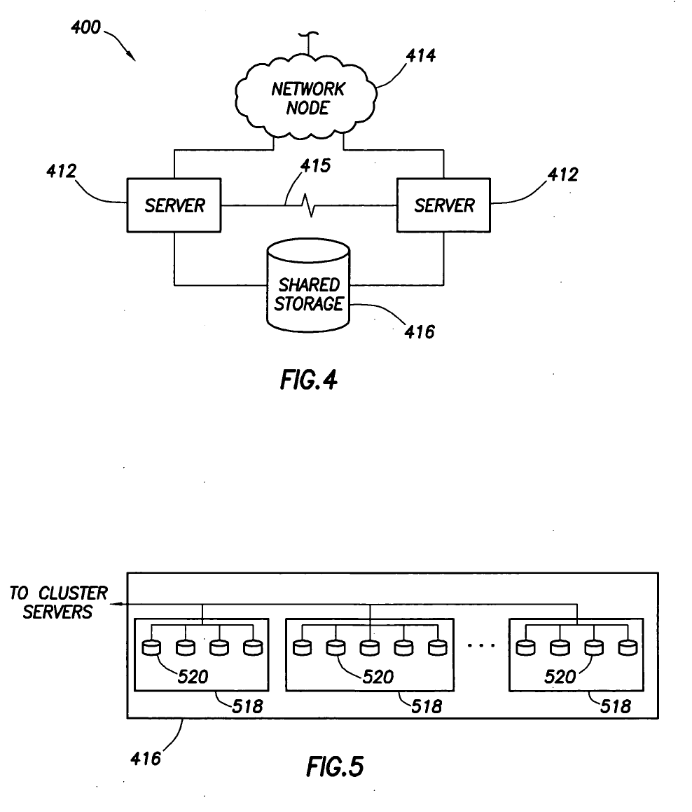

Shown in FIG. 4 is an exemplary embodiment of a two-node server cluster network 400. The server cluster network 400 may include one or more server nodes 412 that may be interconnected to one another by a heartbeat or communications link 415. Each of the server nodes 412 may be coupled to a network node 414, which represents a connection to a communications network served by the server nodes 412. Each of the server nodes 412 may be coupled to a shared storage unit 416. Shown in FIG. 5 is a diagram of the shared storage unit 416, which may include a number of drive arrays 518. Each of the drive arrays 518 may include a number of interconnected storage disks or drives 520 that may be managed according to a fault tolerant data storage methodology, such as a redundant array of inexpensive disks (RAID) methodology. The shared storage unit 416 of FIG. 5 is shown as having three drive arrays 518, although other configurations of shared storage unit 416 may have more or fewer drive arrays 518.

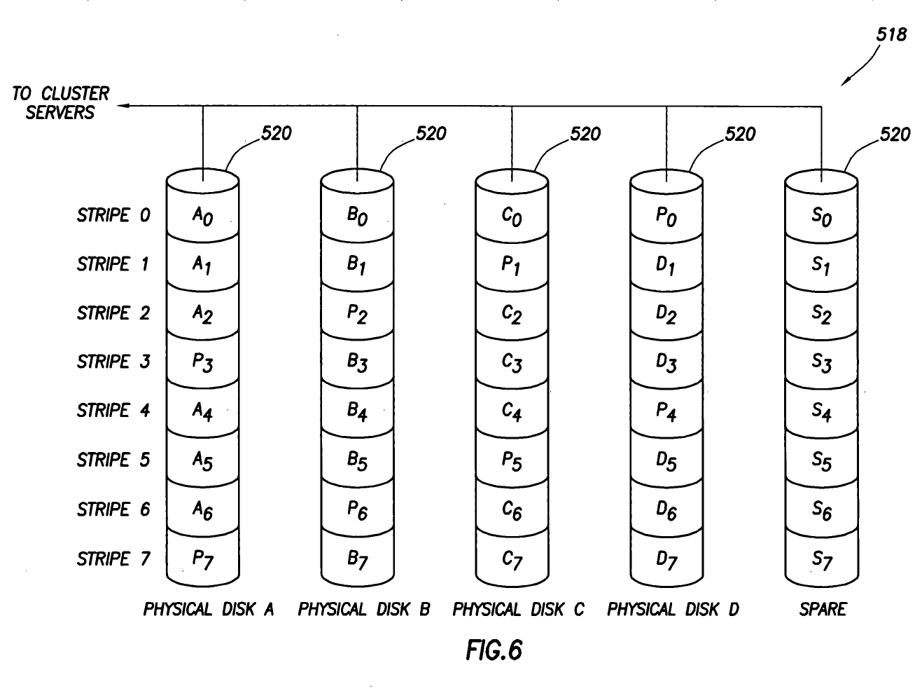

The storage drives 520 of the drive array 518 may operate according to a RAID Level 5 data storage scheme. RAID Level 5 is characterized by the inclusion of a parity strip in each stripe of data as a method of protecting the data of the stripe and of providing for the ability to rebuild or restore the data of the stripe on the basis of the data stored on the remaining strips of data in the data stripe. Shown generally at 518 in FIG. 6 is a diagram of a drive array that may include five data drives 520, labeled Physical Disk A through Physical Disk D, and a spare disk. Each of the four data disk drives 520 in the example of FIG. 6 may includes eight stripes or rows of data, labeled Stripe 0 through Stripe 7. It should be recognized that the configuration of the RAID array 518 of FIG. 6 is an illustration and that an implementation of a RAID array 518 may have more or fewer disk drives 520 with more or fewer stripes or rows, and may be of a different RAID level. The size or width of each stripe of data may be, for example, 64 KB per disk.

With reference to Stripe 0, data A₀, B₀, and C₀ may be stored in Disk A, Disk B, and Disk C, respectively. The parity bits for Stripe 0, which may be the result of an exclusive—OR operation performed on the content of Stripe 0 in Disk A, Disk B, and Disk C, may be stored in Disk D and may be labeled P₀. As a second example of the data structure of the RAID array 518, with reference to Stripe 7, B₇, C₇, and D₇ may be stored in Disk B, Disk C, and Disk D, respectively. The parity bits for Stripe 7, which may be the result of an exclusive—OR operation performed on the content of Stripe 7 in Disk B, Disk C, and Disk D; may be stored in Disk A and may be labeled P₇. If, for example, Disk C were to fail or be replaced, the data in each stripe of Disk C would be rebuilt with the data in the other three disks of the RAID array 518.

The spare storage drive of RAID array 518 may likewise be arranged into a number of logical stripes that mirror the scheme used for the data or active storage drives 520. In this example, the spare storage drive may include seven stripes, labeled S₀-S₇. In normal operation, the spare storage drive is not used as part of the RAID Level 5 data storage scheme. Instead, the spare storage drive exists in the shared storage unit 416 (FIGS. 4 and 5) and can be associated with any one or more of the RAID arrays 518 for the sake of the firmware update process disclosed herein.

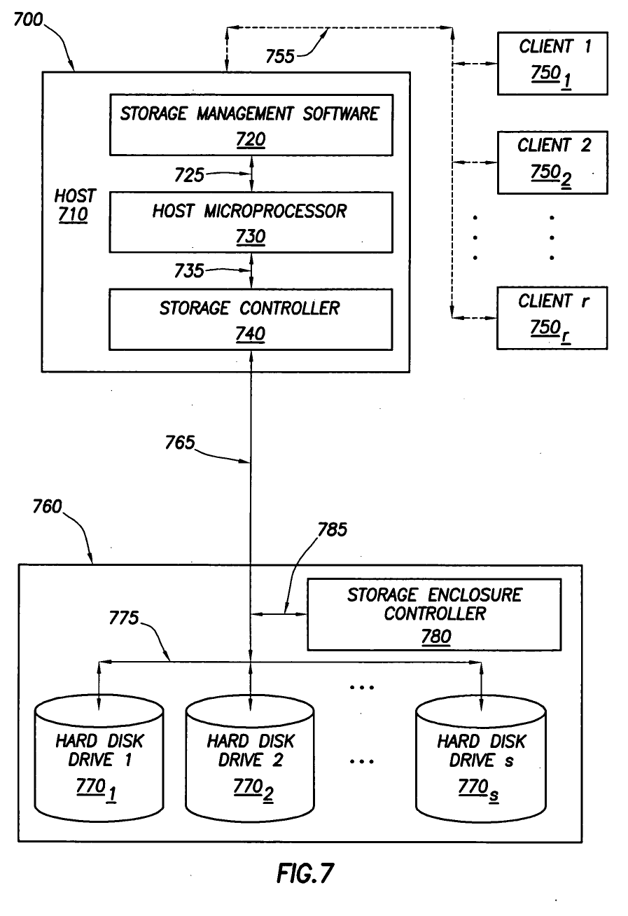

FIG. 7 schematically illustrates a diagram of a system 700 with a host 710, clients 1-r750₁-750ᵣ, respectively, where r=1, 2, . . . , R, with R any finite integer, and a storage subsystem 760, where the system 700 may be useful in various exemplary embodiments, according to teachings of the present disclosure. The host 710 may include storage management software 720 communicatively coupled with a host microprocessor 730 communicatively coupled with a storage controller 740, as shown in FIG. 7, for example, and as indicated by 725 and 735.

The host 710 may be communicatively coupled with the one or more clients 1-r750₁-750ᵣ, as indicated by 755. The host 710 may be communicatively coupled with the storage subsystem 760, as indicated by 765. The storage subsystem 760 may include hard disk drives 1-s770₁-770ₛ, respectively, where s=1, 2, . . . , S, with S any finite integer, communicatively coupled with a storage enclosure controller 780, as shown in FIG. 7, for example. The host 710 may be independently communicatively coupled with the one or more hard disk drives 1-s770₁-770ₛ, and to the storage enclosure controller 780, as indicated by 765, 775, and 785.

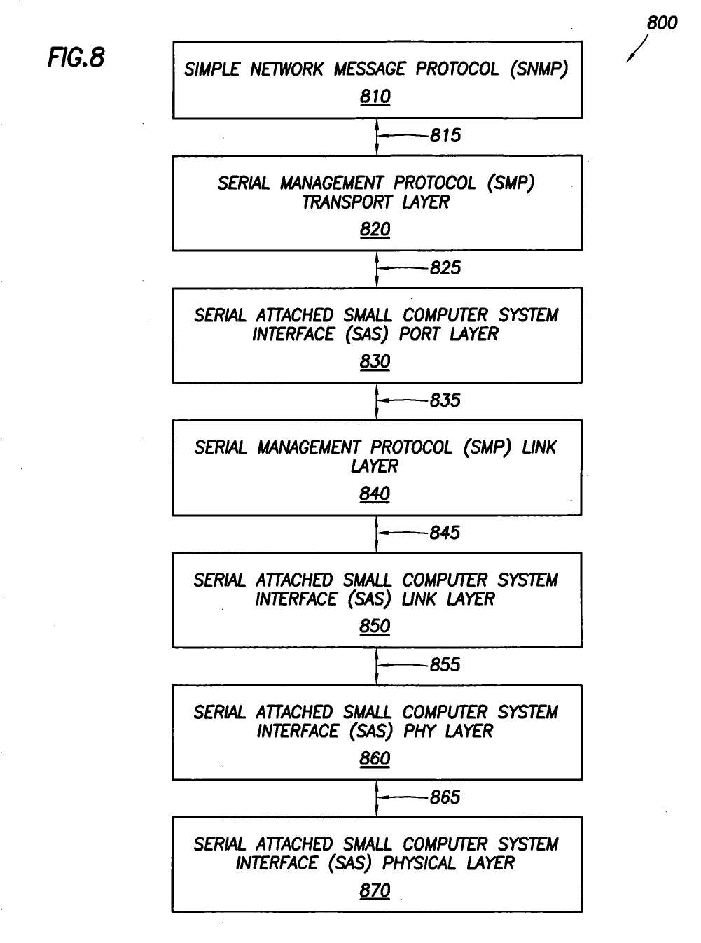

FIG. 8 schematically illustrates a layering 800 of a simple network management protocol (SNMP) 810 over serial attached small computer system interface (SCSI) system (SAS) layers 820-870 of protocols useful in various exemplary embodiments, according to teachings of the present disclosure. The simple network management protocol (SNMP) 810 may be layered above a serial management protocol (SMP) transport layer 820 and communicatively coupled with the serial management protocol (SMP) transport layer 820, as indicated by 815. The serial management protocol (SMP) transport layer 820 may be layered above a serial attached small computer system interface (SCSI) system (SAS) port layer 830 and communicatively coupled with the serial attached small computer system interface (SCSI) system (SAS) port layer 830, as indicated by 825. The small computer system interface (SCSI) system (SAS) port layer 830 may be layered above a serial management protocol (SMP) link layer 840 and communicatively coupled with the serial management protocol (SMP) link layer 840, as indicated by 835.

The serial management protocol (SMP) link layer 840 may be layered above a small computer system interface (SCSI) system (SAS) link layer 850 and communicatively coupled with the small computer system interface (SCSI) system (SAS) link layer 850, as indicated by 845. The small computer system interface (SCSI) system (SAS) link layer 850 may be layered above a small computer system interface (SCSI) system (SAS) phy layer 860 and communicatively coupled with the small computer system interface (SCSI) system (SAS) phy layer 860, as indicated by 855. The small computer system interface (SCSI) system (SAS) phy layer 860 may be layered above a small computer system interface (SCSI) system (SAS) physical layer 870 and communicatively coupled with the small computer system interface (SCSI) system (SAS) physical layer 870, as indicated by 865.

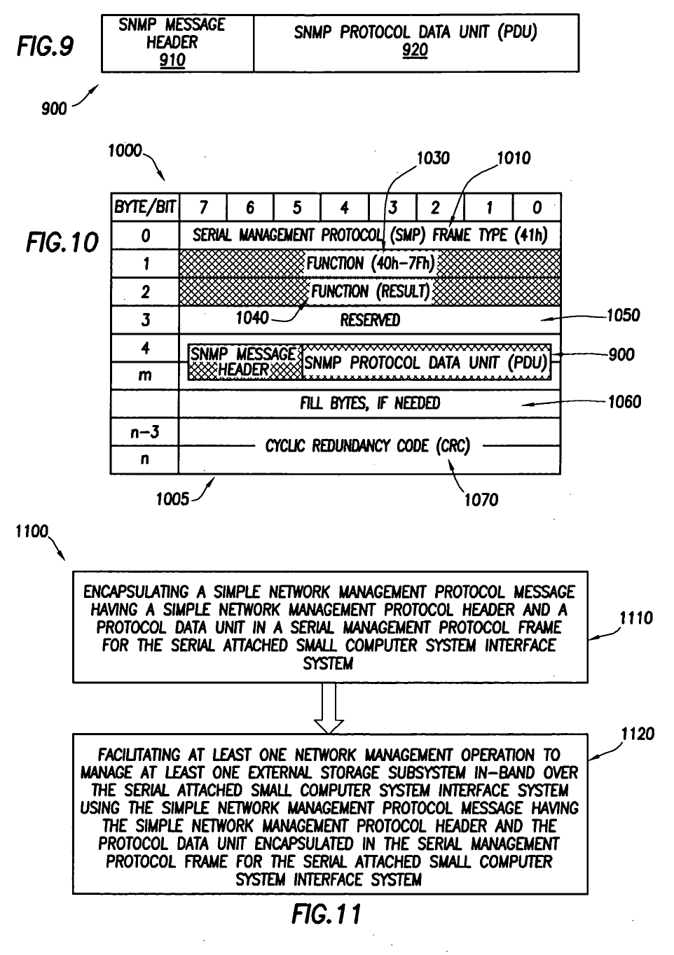

FIG. 9 schematically illustrates a simple network management protocol (SNMP) message 900 having a message header 910 and a protocol data unit (PDU) 920 useful in various exemplary embodiments, according to teachings of the present disclosure. The message header 910 may have addressing information and/or a description of the data in the simple network management protocol (SNMP) message 900. The protocol data unit (PDU) 920 may have the data in the simple network management protocol (SNMP) message 900 included therein.

FIG. 10 schematically illustrates a serial attached small computer system interface (SCSI) system (SAS) serial management protocol (SMP) response frame format 1000 with the simple network management protocol (SNMP) message 900 encapsulated in the serial attached small computer system interface (SCSI) system (SAS) serial management protocol (SMP) frame 1005. FIG. 10 shows the simple network management protocol (SNMP) message 900 tunneling over the serial attached small computer system interface (SCSI) system (SAS) in various exemplary embodiments, according to teachings of the present disclosure. The serial attached SCSI (SAS) specification may provide a framework called the serial management protocol (SMP) for a specific set of storage management operations in-band through the SAS serial links. Under the serial management protocol (SMP), the SAS management function may send a request frame to a target port with an appropriate function code imbedded. The target port may receive the request frame, decode the function code, and send an appropriate response back to the requestor.

The simple network management protocol (SNMP) is also based on a similar request/response protocol where a management system may issue a request and one or more managed devices may return responses. In various illustrative embodiments, a protocol such as the simple network management protocol (SNMP) may be readily encapsulated in the SAS serial management protocol (SMP) framework, as shown in FIG. 10, for example, and may leverage the serial management protocol (SMP) for network-based management operations. For example, the storage controller 740 of the host 710 may send a simple network management protocol (SNMP) message 900 encapsulated in the SAS serial management protocol (SMP) frame 1005 to the storage enclosure controller 780 requesting the storage enclosure controller 780 to monitor the temperature of the storage subsystem 760.

The storage enclosure controller 780 may monitor the temperature of the storage subsystem 760 and respond back to the storage controller 740 of the host 710, using another simple network management protocol (SNMP) message 900 encapsulated in the SAS serial management protocol (SMP) frame 1005. Depending on the temperature of the storage subsystem 760, the storage controller 740 of the host 710 may send yet another simple network management protocol (SNMP) message 900 encapsulated in the SAS serial management protocol (SMP) frame 1005 to the storage enclosure controller 780 requesting the storage enclosure controller 780 to turn on one or more fans in the storage subsystem 760 to control the temperature of the storage subsystem 760 appropriately.

In various illustrative embodiments, as shown in FIG. 10, for example, the SAS serial management protocol (SMP) frame 1005 may have a one-byte function field to define the type of request. The serial attached SCSI (SAS) specification has defined a set of 11 different management functions and left a range of values (40 h-7 Fh) to be vendor specific.

The SAS serial management protocol (SMP) frame 1005 may additionally have a 1024-byte long payload field, which may be long enough to contain the simple network management protocol (SNMP) message 900 having the message header 910 and the protocol data unit (PDU) 920 for simple network management protocol (SNMP) based network management operations. In various illustrative embodiments, as shown in FIG. 10, for example, bytes 4-m may be used to encapsulate the simple network management protocol (SNMP) message 900, where m may be any integer greater than 4 and less than n-3, when the SAS serial management protocol (SMP) frame 1005 may have n+1 total bytes, with n having any appropriate integer value.

In various illustrative embodiments, as shown in FIG. 10, for example, byte 1 may used for an appropriate function value (40 h-7 Fh), as indicated at 1030, and byte 2 may used for an appropriate function result, as indicated at 1040, and byte 3 may reserved, as indicated at 1050. In various illustrative embodiments, as shown in FIG. 10, for example, bytes between byte m and byte (n-3) may be fill bytes, if needed, as indicated at 1060, and bytes (n-3) to n may used for an appropriate cyclic redundancy code (CRC), as indicated at 1070.

FIG. 11 schematically illustrates an exemplary method to encapsulate a simple network management protocol (SNMP) over a serial attached small computer system interface (SCSI) system (SAS) for network management operations to manage external storage subsystems, according to teachings of the present disclosure.

In various illustrative embodiments, as shown in FIG. 11, a method 1100 to encapsulate a simple network management protocol (SNMP) over a serial attached small computer system interface (SCSI) system (SAS) for at least one network management operation to manage at least one external storage subsystem may be provided. The method 1100 may comprise encapsulating a simple network management protocol message having a simple network management protocol header and a protocol data unit in a serial management protocol frame for the serial attached small computer system interface system, as indicated at 1110. The method 1100 may also comprise facilitating the at least one network management operation to manage the at least one external storage subsystem in-band over the serial attached small computer system interface (SCSI) system (SAS) using the simple network management protocol (SNMP) message having the simple network management protocol (SNMP) header and the protocol data unit (PDU) encapsulated in the serial management protocol (SMP) frame for the serial attached small computer system interface (SCSI) system (SAS), as indicated at 1120.

In various illustrative embodiments, as described above, hosts may use the SAS links for all storage operations and may also use the same SAS links for all network-based and/or network-related management operations, including all network-based and/or network-related management operations using the simple network management protocol (SNMP), for example. Consequently, the system and subsystem vendors are not forced to incorporate additional management network interfaces in the designs of storage systems and subsystems in order to facilitate network-based and/or network-related management operations, thereby driving down the costs and decreasing the overall complexity due to the absence of any additional cabling.

In various illustrative embodiments, as described above, the SAS specification may be leveraged by using the room the SAS specification deliberately left open for potential vendor added value. In various particular illustrative embodiments, a function field value in the 40 h-7 Fh range may be utilized for SNMP based network management operations over SAS. SAS vendors may choose to add unique value to their implementations by adding such an SNMP-over-SAS feature and claim to facilitate network management operations in-band over SAS links.

SNMP is a simple request/response protocol where a management system issues a request and managed devices return responses. Although the management system and managed devices typically communicate via the user datagram protocol/internet protocol (UDP/IP) and/or the transmission control protocol/internet protocol (TCP/IP) over an Ethernet, for example, SNMP does not assume that a communication path has been established prior to the transmission of data. Furthermore, SNMP is transport independent and may be implemented on other transports, such as SAS, as described above.

The SNMP transport provider may be responsible for all communication between the SNMP manager and agent. The SNMP transport provider may act as a bridge between the SNMP application programming interface (API) and the actual transport protocol used. For using SAS as the transport protocol, the SAS vendors may implement the protocol and plug-in (and/or register) the protocol with the SNMP transport provider, for example, as shown in FIGS. 8-10, and as described above.

The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, in the sense of Georg Cantor. Accordingly, the protection sought herein is as set forth in the claims below.

Although various illustrative embodiments of the present invention and their advantages are described in detail, a person skilled in the art having the benefit of the present disclosure could make various alterations, additions, and/or omissions without departing from the spirit and scope of the present invention, as defined by the appended claims.

What is claimed is:

1. A method to encapsulate a simple network management protocol over a serial attached small computer system interface system for at least one network management operation to manage at least one external storage subsystem, the method comprising:
encapsulating a simple network management protocol message having a simple network management protocol header and a protocol data unit in a serial management protocol frame for the serial attached small computer system interface system; and
facilitating the at least one network management operation to manage the at least one external storage subsystem in-band over the serial attached small computer system interface system using the simple network management protocol message having the simple network management protocol header and the protocol data unit encapsulated in the serial management protocol frame for the serial attached small computer system interface system.

2. The method of claim 1, wherein encapsulating the simple network management protocol message having the simple network management protocol header and the protocol data unit in the serial management protocol frame for the serial attached small computer system interface system further comprises encapsulating the simple network management protocol message having the simple network management protocol header and the protocol data unit in the serial management protocol frame having at least a one-byte function field to define a type of request.

3. The method of claim 2, wherein encapsulating the simple network management protocol message having the simple network management protocol header and the protocol data unit in the serial management protocol frame for the serial attached small computer system interface system further comprises encapsulating the simple network management protocol message having the simple network management protocol header and the protocol data unit in the serial management protocol frame having at least a 1024-byte payload field to contain the simple network management protocol message having the simple network management protocol header and the protocol data unit for the at least one network management operation.

4. The method of claim 3, wherein encapsulating the simple network management protocol message having the simple network management protocol header and the protocol data unit in the serial management protocol frame for the serial attached small computer system interface system further comprises layering a simple network management protocol above a serial management protocol transport layer and communicatively coupling the simple network management protocol with the serial management protocol transport layer.

5. The method of claim 4, wherein layering the simple network management protocol above the serial management protocol transport layer and communicatively coupling the simple network management protocol with the serial management protocol transport layer further comprises layering the serial management protocol transport layer above a serial attached small computer system interface port layer and communicatively coupling the serial management protocol transport layer with the serial attached small computer system interface port layer.

6. The method of claim 5, wherein layering the serial management protocol transport layer above the serial attached small computer system interface port layer and communicatively coupling the serial management protocol transport layer with the serial attached small computer system interface port layer further comprises layering the serial attached small computer system interface port layer above a serial management protocol link layer and communicatively coupling the serial attached small computer system interface port layer with the serial management protocol link layer.

7. The method of claim 6, wherein layering the serial attached small computer system interface port layer above the serial management protocol link layer and communicatively coupling the serial attached small computer system interface port layer with the serial management protocol link layer further comprises layering the serial management protocol link layer above a serial attached small computer system interface link layer and communicatively coupling the serial management protocol link layer with the serial attached small computer system interface link layer.

8. The method of claim 7, wherein layering the serial management protocol link layer above the serial attached small computer system interface link layer and communicatively coupling the serial management protocol link layer with the serial attached small computer system interface link layer further comprises layering the serial attached small computer system interface link layer above a serial attached small computer system interface phy layer and communicatively coupling the serial attached small computer system interface link layer with the serial attached small computer system interface phy layer.

9. The method of claim 8, wherein layering the serial attached small computer system interface link layer above the serial attached small computer system interface phy layer and communicatively coupling the serial attached small computer system interface link layer with the serial attached small computer system interface phy layer further comprises layering the serial attached small computer system interface phy layer above a serial attached small computer system interface physical layer and communicatively coupling the serial attached small computer system interface phy layer with the serial attached small computer system interface physical layer.

10. A method to encapsulate a simple network management protocol over a serial attached small computer system interface system for network management operations to manage external storage subsystems, the method comprising:
encapsulating a simple network management protocol message having a simple network management protocol header and a protocol data unit in a serial management protocol frame for the serial attached small computer system interface system, the serial management protocol frame having at least a one-byte function field to define a type of request and at least a 1024-byte payload field to contain the simple network management protocol message having the simple network management protocol header and the protocol data unit for the network management operations; and
facilitating the network management operations to manage the external storage subsystems in-band over the serial attached small computer system interface system using the simple network management protocol message having the simple network management protocol header and the protocol data unit encapsulated in the serial management protocol frame for the serial attached small computer system interface system.

11. The method of claim 10, wherein encapsulating the simple network management protocol message having the simple network management protocol header and the protocol data unit in the serial management protocol frame for the serial attached small computer system interface system further comprises layering a simple network management protocol above a serial management protocol transport layer and communicatively coupling the simple network management protocol with the serial management protocol transport layer.

12. The method of claim 11, wherein layering the simple network management protocol above the serial management protocol transport layer and communicatively coupling the simple network management protocol with the serial management protocol transport layer further comprises layering the serial management protocol transport layer above a serial attached small computer system interface port layer and communicatively coupling the serial management protocol transport layer with the serial attached small computer system interface port layer.

13. The method of claim 12, wherein layering the serial management protocol transport layer above the serial attached small computer system interface port layer and communicatively coupling the serial management protocol transport layer with the serial attached small computer system interface port layer further comprises layering the serial attached small computer system interface port layer above a serial management protocol link layer and communicatively coupling the serial attached small computer system interface port layer with the serial management protocol link layer.

14. The method of claim 13, wherein layering the serial attached small computer system interface port layer above the serial management protocol link layer and communicatively coupling the serial attached small computer system interface port layer with the serial management protocol link layer further comprises layering the serial management protocol link layer above a serial attached small computer system interface link layer and communicatively coupling the serial management protocol link layer with the serial attached small computer system interface link layer.

15. The method of claim 14, wherein layering the serial management protocol link layer above the serial attached small computer system interface link layer and communicatively coupling the serial management protocol link layer with the serial attached small computer system interface link layer further comprises layering the serial attached small computer system interface link layer above a serial attached small computer system interface phy layer and communicatively coupling the serial attached small computer system interface link layer with the serial attached small computer system interface phy layer.

16. The method of claim 15, wherein layering the serial attached small computer system interface link layer above the serial attached small computer system interface phy layer and communicatively coupling the serial attached small computer system interface link layer with the serial attached small computer system interface phy layer further comprises layering the serial attached small computer system interface phy layer above a serial attached small computer system interface physical layer and communicatively coupling the serial attached small computer system interface phy layer with the serial attached small computer system interface physical layer.

17. A method to encapsulate a simple network management protocol over a serial attached small computer system interface system for network management operations to manage external storage subsystems, the method comprising:
encapsulating a simple network management protocol message having a simple network management protocol header and a protocol data unit in a serial management protocol frame for the serial attached small computer system interface system, using fill bytes as needed, the serial management protocol frame having at least a one-byte function field to define a type of request and at least a 1024-byte payload field to contain the simple network management protocol message having the simple network management protocol header and the protocol data unit for the network management operations, layering a simple network management protocol above a serial management protocol transport layer and communicatively coupling the simple network management protocol with the serial management protocol transport layer, layering the serial management protocol transport layer above a serial attached small computer system interface port layer and communicatively coupling the serial management protocol transport layer with the serial attached small computer system interface port layer, and layering the serial attached small computer system interface port layer above a serial management protocol link layer and communicatively coupling the serial attached small computer system interface port layer with the serial management protocol link layer; and
facilitating the network management operations to manage the external storage subsystems in-band over the serial attached small computer system interface system using the simple network management protocol message having the simple network management protocol header and the protocol data unit encapsulated in the serial management protocol frame for the serial attached small computer system interface system.

18. The method of claim 17, wherein layering the serial attached small computer system interface port layer above the serial management protocol link layer and communicatively coupling the serial attached small computer system interface port layer with the serial management protocol link layer further comprises layering the serial management protocol link layer above a serial attached small computer system interface link layer and communicatively coupling the serial management protocol link layer with the serial attached small computer system interface link layer.

19. The method of claim 18, wherein layering the serial management protocol link layer above the serial attached small computer system interface link layer and communicatively coupling the serial management protocol link layer with the serial attached small computer system interface link layer further comprises layering the serial attached small computer system interface link layer above a serial attached small computer system interface phy layer and communicatively coupling the serial attached small computer system interface link layer with the serial attached small computer system interface phy layer.

20. The method of claim 19, wherein layering the serial attached small computer system interface link layer above the serial attached small computer system interface phy layer and communicatively coupling the serial attached small computer system interface link layer with the serial attached small computer system interface phy layer further comprises layering the serial attached small computer system interface phy layer above a serial attached small computer system interface physical layer and communicatively coupling the serial attached small computer system interface phy layer with the serial attached small computer system interface physical layer.
